(19) United States
(12) Patent Application Publication
(10) Pub. No.: US 2011/0291435 A1
(43) Pub. Date: Dec. 1, 2011

(54) GAP HIDER FOR ASSIST GRIP

(75) Inventors: Andrew MATUSKO, Dexter, MI (US); Dan HAWKINS, Milford, MI (US)

(73) Assignee: International automotive Components Group North America Inc., Dearborn, MI (US)

(21) Appl. No.: 12/786,976

(22) Filed: May 25, 2010

(51) Int. Cl. B60N 3/02

(52) U.S. Cl. 296/1.02; 296/1.08

(57) ABSTRACT

A gap hider is provided for closing an opening between the ends of an assist grip and a trim panel, the gap hider fitting into a recess in the ends of the assist grip such that no adhesive or fasteners are needed. The gap hider provides that the trim panel can be deployed from beneath a portion of the assist grip without effecting the side air bag deployment.

### FIELD

The present disclosure relates to an assist grip or grab handle for entering or exiting a vehicle, and more particularly, to an assist grip or grab handle including a gap hider which lies within the plastic trim for a vehicle and which does not interfere with side air bag deployment of the pillar trim.

### BACKGROUND

Today's motor vehicles may include numerous air bag systems which may inflate from behind one or more trim panels to provide protection for the occupants of the vehicle in the event of a collision. These air bags may be deployed from behind the instrument panel, from within the steering wheel, from the sides of seats and from pillar and rail trim panels to cushion an impact by inflating between a portion of a vehicle body and the occupant. Side impact air bags are designed to support the head of the occupant at the time of a collision in the side of the vehicle or the like, and absorb the kinetic energy of the head of the occupant.

For example, an air bag apparatus such as a curtain may be disposed in a curved interior portion extending from a front body pillar (so-called A-pillar) positioned beside a windshield and extending along the roof of the vehicle. The air bag apparatus may be structured such that when an acceleration sensor detects a great acceleration from a side direction of the vehicle, the air bag apparatus may actuate an inflator and the air bag may be inflated and expanded by supplying a high pressure gas generated in an inflator into the air bag.

The folded air bag, prior to deployment, may be housed within a space between the front body pillar and roof rail of the vehicle and interior garnish or trim panels such that it is out of sight until needed, when the inflating bag can break through or deflect the trim panels out of its' path.

Grab handles or assist grips are well known in vehicles to aid in exiting or entering the vehicle. These are particularly useful for assisting in exiting the back seat and are often hinged to retract out of the way. For larger vehicles, like SUV's or trucks, a grab handle may be rigidly mounted to the A-pillar of the vehicle to assist in entry since such vehicles may have the passenger space relatively high above the ground.

The attachment of grab handles requires a rigid connection that can withstand the weight of large individuals and accordingly may be connected to fixed structure of the vehicle. This may present a challenge to design engineers regarding how to interface the pillar trim or garnish with the rigid assist handle and provide a pleasing appearance yet not adversely effect the deployment of the air bag or curtain.

### SUMMARY

In one exemplary embodiment, the present disclosure relates to a structure for closing an opening in a vehicle, comprising a trim panel including two openings and an assist grip having two end sections which end sections fill a portion of said trim panel openings and wherein a portion of said trim panel openings are not filled by the assist grip. The assist grip includes a recess. One or more gap hiders are provided which engage the recess in the assist grip and which gap hider fills the portions of the trim panel openings that are not filled by the assist grip.

In another exemplary embodiment the present disclosure relates to A pillar trim structure for an airbag comprising a pillar in a vehicle and an assist grip attached to the pillar, the assist grip having a middle portion and two ends. A trim panel is provided which in a first position overlies the pillar, wherein the trim panel includes at least two openings for the assist grip ends to pass through leaving a remaining portion not filled by the ends of the assist grip. One or more gap hiders are attached to the ends wherein the gap hider fills the portions of the trim panel openings that are not filled by the ends of said assist grip. The ends of the assist grip include a recess which engages the gap hider wherein the trim panel is configured to be disposed to a second position not overlying the pillar by the expansion of the air bag.

### BRIEF DESCRIPTION OF THE DRAWINGS

The features, operation and advantages of the invention may be better understood from the following detailed description of the preferred embodiments taken in conjunction with the attached drawings, in which

FIG. 1 is a schematic view of the right side of the interior of an automobile, illustrating the placement of a grab handle or assist grip, according to the present disclosure, on the A-pillar;

FIG. 2 is a perspective view of the assist grip of FIG. 1 looking from the open front window towards the windshield;

FIG. 3 is a perspective view of the assist grip, according to the present disclosure, before installation in the vehicle;

FIG. 4 is another perspective view of the assist grip of FIG. 3 illustrating one end with the gap hider removed, further illustrating means for attaching the gap hider;

FIG. 5 is a top view of the gap hider of FIG. 4, according to the present disclosure.

### DETAILED DESCRIPTION

Still other objects and advantages of the present invention will become readily apparent to those skilled in the art from the following detailed description, wherein it is shown and described preferred embodiments of the invention. As will be realized the invention is capable of other and different embodiments, and its several details are capable of modification in various respects, without departing from the invention. Accordingly, the description is to be regarded as illustrative in nature and not as restrictive.

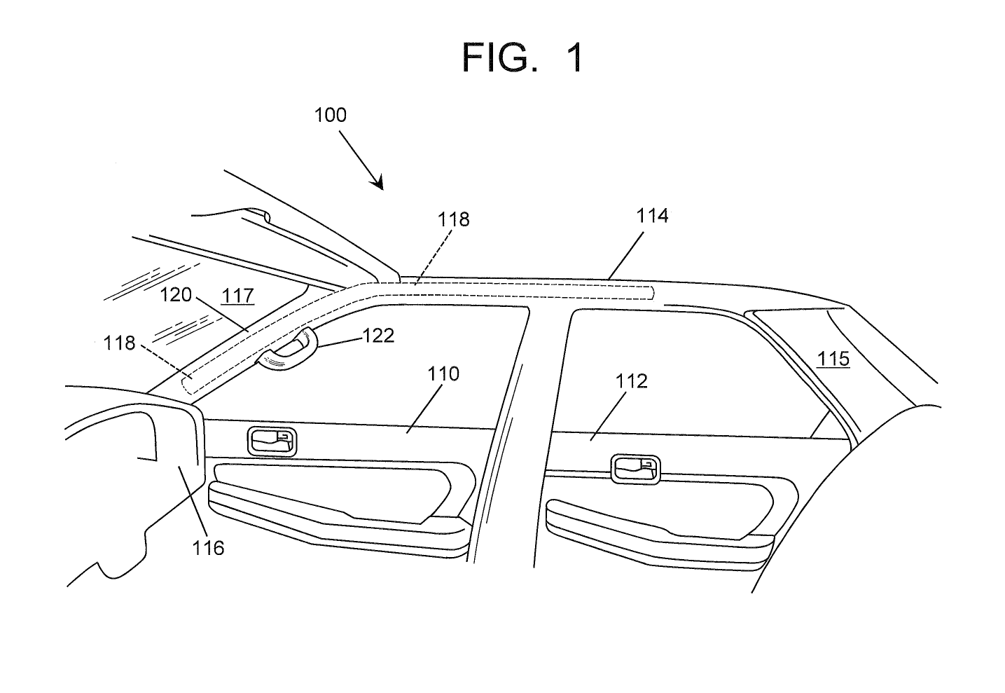

FIG. 1 is a schematic view of the passenger side of the interior 100 of an automobile, illustrating the placement of a grab handle or assist grip 122 on the A-pillar trim panel 120. The interior may further include front 110 and rear 112 doors, an instrument panel 116 and a roof rail trim panel 114 that spans the distance from the A-pillar trim panel 120 to the C-pillar trim panel 115. Reference to A-pillar trim panel may be understood as the trim panel that covers the A-pillar located at the front of the vehicle that connects the roof to the vehicle frame. Similarly, the B-pillar is positioned about the mid-point of the vehicle and the C-pillar is at the rear of the passenger compartment. A curtain air bag 118 (dashed lines) may be stored in deflated condition behind the roof rail trim panel 114 and/or A-pillar trim panel 120 and may be deployed to protect an occupant in the case of a side collision, by deflecting the trim panels out of their normal position. Additional assist grips may be located on the roof rail trim panel over the front door and/or rear door. Such assist grips may facilitate entry into and exit from the vehicle.

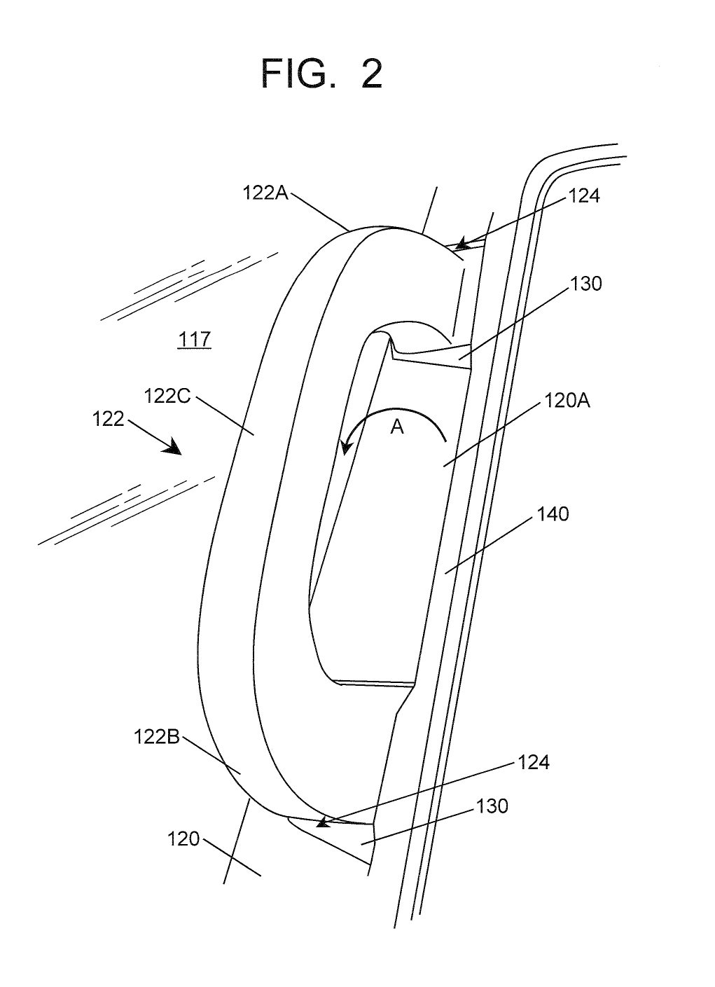

FIG. 2 is a perspective view of the assist grip 122 looking from the open window of the front door 110 towards the windshield 117. The door seal portion 140 of the A-pillar is shown adjacent the trim panel 120. The assist grip 122 preferably comprises an inverted U-shape including two ends 122A, 122B and a middle portion 122C. The ends 122A, 122B may attach to the A-pillar metal structure of the vehicle which is covered by trim panel 120. Generally, the color, texture and gloss of the assist grip 122 and the trim panel 120 are coordinated to provide a pleasing appearance and may even comprise the same plastic material, for instance polypropylene or polyolefin, and be color-matched.

Accordingly, it may be appreciated that as shown in FIG. 2, the opening 124 may be defined by three sides of the trim panel 120. It is contemplated herein that the opening for use in conjunction with the gap hider herein may be within the trim panel, and therefore defined by four sides of the trim panel.

As shown in FIG. 2, the trim panel 120 that covers the A-pillar may be designed to rotate (see arrow A) towards the windshield 117 by the deploying air bag to prevent the panel 120 from being interfered with by the assist grip. To provide a one-piece trim panel molding that is aesthetically pleasing, the panel may include openings 124 which the ends 122A, 122B of the assist grip 122 may pass through for attachment to the A-pillar. The openings may lie at an edge of the trim panel 120 which may allow a portion 120A of the trim panel 120 to lie beneath the middle portion 122C of the assist grip and allow the trim panel to be molded in one piece, eliminating joint lines.

It may not be possible to design the dimensions of the openings 124 to be the same as the dimensions of the ends 122A, 122B due to tolerancing of the mating parts. Accordingly, to provide an aesthetically pleasing transition from trim panel 120 to the assist grip 122, a gap hider 130 may be provided to bridge the opening 124. The gap hider 130 may comprise a thin relatively flexible plastic molding that may have a color, gloss and texture that coordinates with the surrounding grip and trim panel.

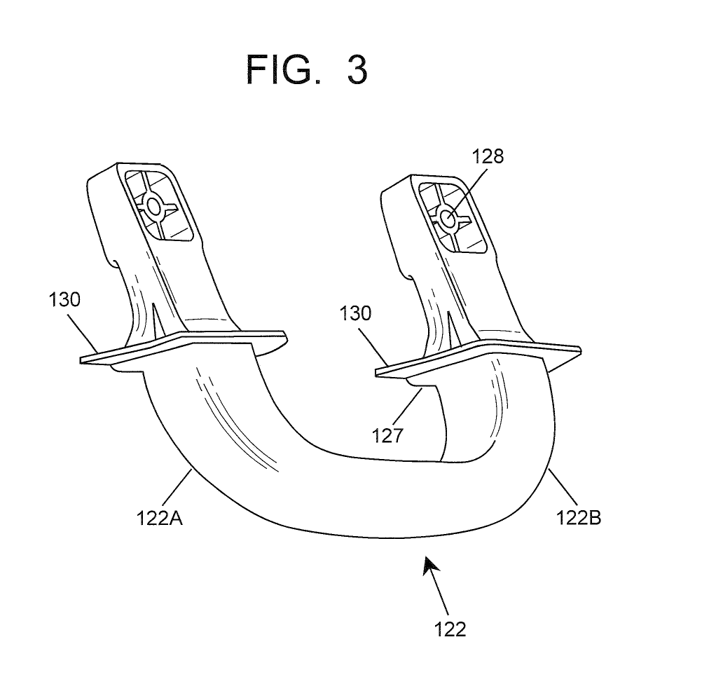

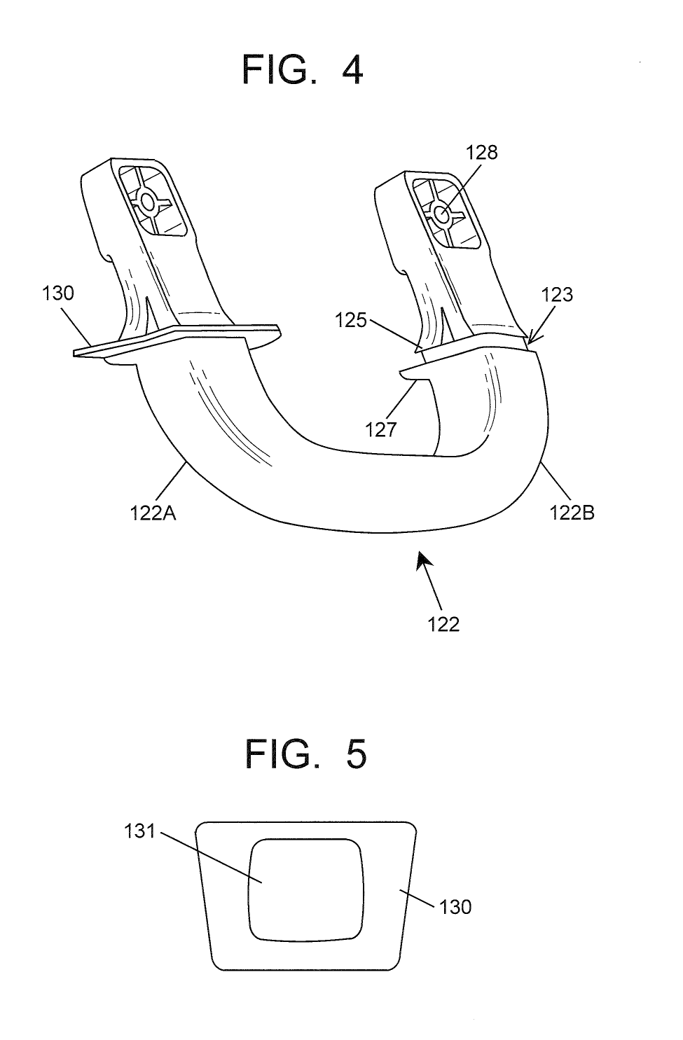

FIG. 3 is a perspective view of the assist grip 122 before installation in the A-pillar of the vehicle. The ends 122A, 122B may each include structure 128 for attachment to the A-pillar metal structure, such as apertures through which a screw may be driven. The gap hider 130 may be slipped over an end 122A, 122B and fitted into a recess 123 (see FIG. 4) to position and secure the gap hider 130 in place. The assist grip 122 may also include flanges 127 that may smooth the transition of the surface of the assist grip to blend with the surface of the A-pillar trim panel.

FIG. 4 is another perspective view of the assist grip 122 illustrating one end 122B with the gap hider 130 removed, and further illustrating the recess 123 surrounding the end which the gap hider may fit into to provide an appealing fit. A recess may therefore be understood as surface that is lower than adjacent surfaces, which may preferably extend about the entire end of the grab handle, an example of which is illustrated in FIG. 4. In other words, the dimensions of the opening 131 in the gap hider 130 (see FIG. 5) may be less than the dimensions of the end 122A, 122B of the assist grip adjacent the recess 123 to assure a relatively tight fit. It may therefore be appreciated that the length and width of the opening 131 coincides and is substantially the same as the length and width of the cross-section defined by the recess 123. More specifically the length and width of the opening 131 may be within +/−5.0% or less of the length and width of the cross-section defined by the recess 123. Preferably, the gap hider has a length and width that is less than the length and width of the cross-section defined by the recess 123. Accordingly, it may be appreciated that when the length and width of the opening in the gap hider is less than the length and width of the cross-section defined by the recess 123, the gap hider will be constrained on the assist grip. In addition, the gap hider 130 may further be retained on the ends 122A, 122B by a detent 125 or ramp that the gap hider must be slipped over during assembly to act as a die-lock.

FIG. 5 is a top view of the gap hider 130 illustrating the overall shape and the central opening 131 that provides a relatively tight fit into recess 123. The overall dimensions of the gap hider 130 may be such that they bridge one or more openings 124 in the trim panel 122 and extend behind the trim panel to provide an appealing transition. Accordingly, the gap hider may seat within the recess and may fully or partially surround the end of the assist grip.

The gap hider may be formed of relatively flexible, relatively low cost polymer such as, but not limited to, thermoplastic elastomers, including cross-linked thermoplastic elastomers, and thermoplastic rubbers. Such polymers may include styrenic block copolymers, polyolefin blends, elastomeric alloys (Dryflex®, Santoprene®, Geoplast®, Sarlink®, Alcryn®), thermoplastic polyurethanes, thermoplastic copolyesters and thermoplastic polyamides. The gap hider may have a thickness of about 0.5-2.5 mm, including all values and increments therein, in 0.1 mm increments.

It may also be appreciated that due to the undercut condition (recess) holding the gap hider in place on the end of the assist grip (see item 123 in FIG. 4), the gap hider may be positioned on the grab handle 122 in the absence of an adhesive and/or mechanical fasteners. This of course eliminates the need for such components (adhesives and/or mechanical fasteners) and therefore provides gap hider without the additional materials and processing otherwise required when adhesives or mechanical fasteners are employed.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

1. A structure for closing an opening in a vehicle, comprising:
a trim panel including two openings;
an assist grip having two end sections which end sections fill a portion of said trim panel openings and wherein a portion of said trim panel openings are not filled by said assist grip and wherein said assist grip end sections include a recess;
one or more gap hiders which engages said recess in said assist grip and which gap hider fills said portions of said trim panel openings that are not filled by said assist grip; and
wherein said gap hider includes an opening and said gap hider opening has a length and width and wherein said recess defines a cross-section in said assist grip having a length and width and wherein said length and width of said opening in said gap hider is within +/−5.0% of the length and width of said cross-section defined by said recess.

2. The structure of claim 1 wherein said assist grip includes a middle portion and said middle portion overlies a portion of said trim panel between said openings.

3. (canceled)

4. The structure of claim 1 wherein said length and width of said opening in said gap hider is less than said length and width of said cross-section defined by said recess and said gap hider is constrained on said assist grip.

5. The structure of claim 1 wherein the gap hider comprises a thermoplastic elastomer, a cross-linked thermoplastic elastomer, or a thermoplastic rubber.

6. The structure of claim 1 wherein said gap hider has a thickness of between 0.5-2.5 mm.

7. The structure of claim 1 wherein said gap hider surrounds said end section of said assist grip.

8. The structure of claim 1 wherein said trim panel includes an edge and said openings are at said edge of said trim panel and are defined by three sides of said trim panel.

9. The structure of claim 1 wherein said openings are within said trim panel and are defined by four sides of said trim panel.

10. The structure of claim 1 wherein said trim panel covers an air bag in a vehicle and said airbag, upon deployment, deflects said trim panel without interference from said assist grip.

11. A pillar trim structure for an airbag comprising:
a pillar in a vehicle;
an assist grip attached to said pillar, the assist grip having a middle portion and two ends;
a trim panel in a first position overlying said pillar, wherein the trim panel includes at least two openings for said assist grip ends to pass through, leaving a remaining portion not filled by said ends of said assist grip;
one or more gap hiders attached to said ends which gap hider fills said portions of said trim panel openings that are not filled by said ends of said assist grip;
wherein said ends of said assist grip include a recess which engages said gap hider;
wherein the trim panel is configured to be disposed to a second position not overlying said pillar by the expansion of the air bag; and
wherein said gap hider includes an opening and said gap hider opening has a length and width and wherein said recess defines a cross-section in said assist grip having a length and width and wherein said length and width of said opening in said gap hider is within +/−5.0% of the length and width of said cross-section defined by said recess.

12. The structure of claim 11 wherein said assist grip includes a middle portion and said middle portion overlies a portion of said trim panel between said openings.

13. (canceled)

14. The structure of claim 13 wherein said length and width of said opening in said gap hider is less than said length and width of said cross-section defined by said recess and said gap hider is constrained on said assist grip.

15. The structure of claim 11 wherein the gap hider comprises a thermoplastic elastomer, a cross-linked thermoplastic elastomer, or a thermoplastic rubber.

16. The structure of claim 11 wherein said gap hider has a thickness of between 0.5-2.5 mm.

17. The structure of claim 11 wherein said trim panel includes an edge and said openings are at said edge of said trim panel and are defined by three sides of said trim panel.

18. The structure of claim 11 wherein said openings are within said trim panel and are defined by four sides of said trim panel.
